(19) United States
(12) Patent Application Publication
(10) Pub. No.: US 2014/0244926 A1
(43) Pub. Date: Aug. 28, 2014

(54) Dedicated Memory Structure for Sector Spreading Interleaving

(71) Applicant: LSI CORPORATION, San Jose, CA (US)

(72) Inventors: Shaohua Yang, San Jose, CA (US); Shu Li, San Jose, CA (US); Bruce A. Wilson, San Jose, CA (US)

(73) Assignee: LSI CORPORATION, San Jose, CA (US)

(21) Appl. No.: 13/777,825

(22) Filed: Feb. 26, 2013

(51) Int. Cl. G06F 12/06

(52) U.S. Cl. CPC G06F 12/0607
USPC 711/112

(57) ABSTRACT

The present disclosure is directed to a method for managing a memory. The method includes the step of receiving data, the data including a plurality of sectors. The method also includes the step of dividing each sector of the plurality of sectors into a plurality of data units. A further step of the method involves interleaving the plurality of data units to yield a plurality of interleaved data units. The method also includes the step of writing the plurality of interleaved data units to a disk. An additional step of the method is to de-spread the plurality of interleaved data units to yield at least one sector of the plurality of sectors.

### BACKGROUND

Current memory structures may have wide variation in the signal to noise ratio across the different blocks of the memory. This wide variation in the signal to noise ratio can be problematic.

Therefore, there exists a need for improved methods and systems for managing memory structures that address the variation in signal to noise ratio across the blocks of the memory structure.

### SUMMARY

The present disclosure is directed to a method for managing a memory. The method includes the step of receiving data, the data including a plurality of sectors. The method also includes the step of dividing each sector of the plurality of sectors into a plurality of data units. A further step of the method involves interleaving the plurality of data units to yield a plurality of interleaved data units. The method also includes the step of writing the plurality of interleaved data units to a disk. An additional step of the method is to de-spread the plurality of interleaved data units to yield at least one sector of the plurality of sectors.

The present disclosure is also directed to a system for managing data. The system includes a memory configured for storing the data. The data includes a plurality of sectors. The system also includes a spreader module configured for dividing each sector of the plurality of sectors into a plurality of data units. The spreader module is also configured for interleaving the plurality of data units to yield a plurality of interleaved data units and for sending the plurality of interleaved data units to a storage device. The storage device is configured for storing the plurality of interleaved data units. The system also includes a de-spreading module configured for receiving the plurality of interleaved data units from the storage device and de-spreading the plurality of interleaved data units to yield at least one sector of the plurality of sectors.

The present disclosure is also directed to a system for dynamically managing data. The system includes a memory configured for storing the data which includes a plurality of sectors. The system also includes a spreader module having a first spreader table and a second spreader table. The first spreader table is configured for dividing each sector of the plurality of sectors into a plurality of data units. The first spreader table is further configured for interleaving the plurality of data units to yield a plurality of interleaved data units and to send the plurality of interleaved data units to a scheduler module. The second spreader table is configured to divide each sector of the plurality of sectors into a plurality of data units and interleave the plurality of data units when the first spreader table is full. The system also includes a scheduler module configured for receiving the plurality of interleaved data units from the spreader module and sending the plurality of interleaved data units to the de-spreading module. The system also includes a de-spreading module configured for de-spreading the plurality of interleaved data units to yield the at least one sector of the plurality of sectors.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 shows a diagram of an embodiment of a system for managing data;

FIG. 2A shows a diagram of spreading of sectors;

FIG. 2B shows a diagram of spreading of sectors;

FIG. 3 shows a block diagram of an additional embodiment of a system for managing data;

FIG. 4A shows a block diagram of a combined Y buffer and system for managing data;

FIG. 4B shows a diagram of spreading of sectors; and

FIG. 5 shows a flow diagram of a method for managing data.

### DETAILED DESCRIPTION

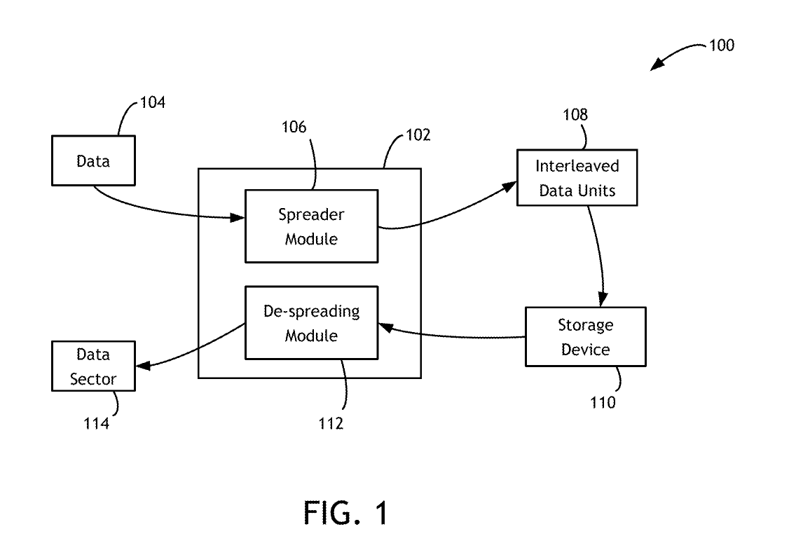

Reference will now be made in detail to the subject matter disclosed, which is illustrated in the accompanying drawings. Referring generally to FIG. 1, a system 100 for managing data is provided. The system 100 includes a memory 102. The memory 102 is configured for storing data 104. The data 104 includes a plurality of sectors. The system 100 also includes a spreader module 106. The spreader module 106 is configured for dividing the data 104 into a plurality of data units. The spreader module 106 is also configured for interleaving the plurality of data units to yield a plurality of interleaved data units 108. The spreader module 106 is further configured for sending the plurality of interleaved data units 108 to a storage device 110. The storage device 110 is configured for storing the plurality of interleaved data units 110. The system 100 also includes a de-spreading module 112. The de-spreading module 112 is configured for receiving the plurality of interleaved data units 108 from the storage device 110 and de-spreading the plurality of interleaved data units 108 to yield a data sector 114 of the data 104. De-spreading in this disclosure refers to the process of un-interleaving the interleaved data to yield the original data sectors before the interleaving process began.

In one embodiment, the de-spreading module 112 of the system 100 as shown in FIG. 1 is further configured for de-spreading the plurality of interleaved data units to yield an additional sector of the data 104. This process may continue until all of the original sectors of the data 104 have been de-spread. In one embodiment, the data includes sixteen sectors having a size of 4 kilobytes each. Those skilled in the art will appreciate that the system 100 is not limited to a specific number of sectors or sector sizes, and the system 100 may include different numbers of sectors without departing from the scope of the present disclosure.

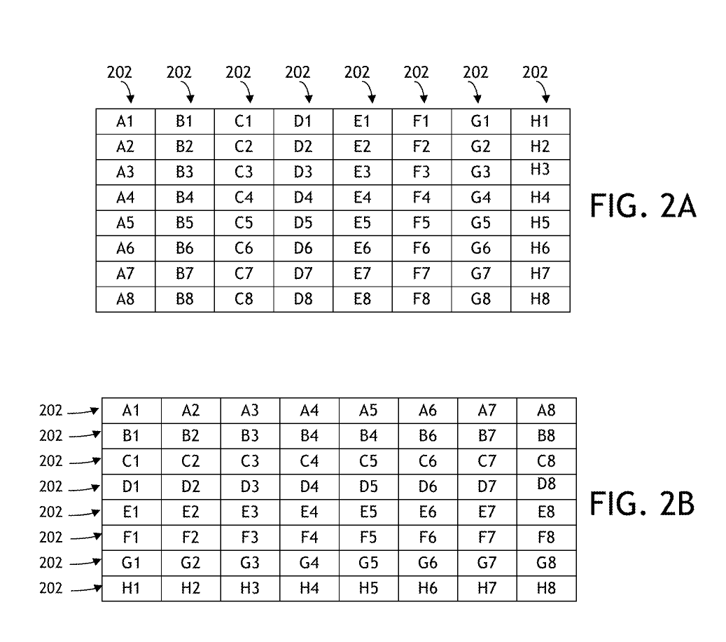

Examples of how the spreader module 106 spreads the data 104 is provided in FIGS. 2A and 2B. In the embodiment shown in FIG. 2A, the data 104 includes eight sectors 202. Each sector 202 is assigned a letter, with the first sector assigned letter A, the second sector assigned letter B, the third sector assigned letter C, the fourth sector assigned letter D, the fifth sector assigned letter E, the sixth sector assigned letter F, the seventh sector assigned letter G, and the eighth sector assigned letter H. The spreader module 106 receives the data 104 including the eight sectors 202 and divides each sector 202 into a plurality of data units. For example, first sector A is divided into eight data units, represented by A1, A2, A3, A4, A5, A6, A7, and A8 in FIG. 2A. The remaining seven sectors 202 are also divided into eight data units.

The spreader module interleaves the data as shown in FIG. 2A. The first line consists of a first data unit of each of the sectors 202, represented as A1, B1, C1, D1, E1, F1, G1, and H1 in FIG. 2A. Next, a second data unit of each sector 202 is interleaved represented as A2, B2, C2, D2, E2, F2, G2, and H2 in FIG. 2A. The spreader module continues interleaving the data until the eighth data unit of each of the eight sectors is reached. The interleaved data is then written to the storage device.

The step of dividing the data into a plurality of data units and then interleaving the data and saving the interleaved data to the storage device separates the data units of the same data sector into different locations on the storage device, instead of consecutive locations on the storage device. In one embodiment, this provides the advantage of improving the signal to noise ratio for the data because in many cases if one data sector does not have a good signal to noise ratio, the adjacent data sectors will not have a good signal to noise ratio either. By dividing the sector into a plurality of data units and interleaving the data units, the signal to noise ratio is averaged out and improved overall. In one embodiment, the steps of dividing the data into a plurality of data units, interleaving the data units, and storing the interleaved data units to a storage device are performed continuously.

Once a complete sector 202 has been written to the storage device, the data from that sector is ready for de-spreading. For example, after interleaving the first data unit of each sector (A1-H1) through the seventh data unit of each sector (A7-H7), the spreader will begin interleaving the eighth data unit of each sector (A8-H8), beginning with A8. Once A8 is written, the complete sector (A1-A8) is ready for de-spreading. Similarly, once B8 is written, the complete sector B1-B8 is ready for de-spreading.

The memory holding the interleaved data is released once the sector has been de-spread and sent to the controller. An example of how the memory used by the interleaved data may be released and then filled with new interleaved data is provided in FIG. 2B. In FIG. 2B, the sector represented by A1-A8 has been spread, written, de-spread, and sent to a controller. The memory slots previously occupied by the data units A1-A8 can now be released. FIG. 2A shows the left hand column previously filled with the data sector A1-A8 now available to receive new data. A first data unit of eight different sectors (sectors A-H) is interleaved into the column as A1, B1, C1, D1, E1, F1, G1, and H1. Next, a second data unit of eight different sectors is interleaved into the next column as A2, B2, C2, D2, E2, F2, and G2. The interleaving continues until the eighth data unit of each sector has been interleaved.

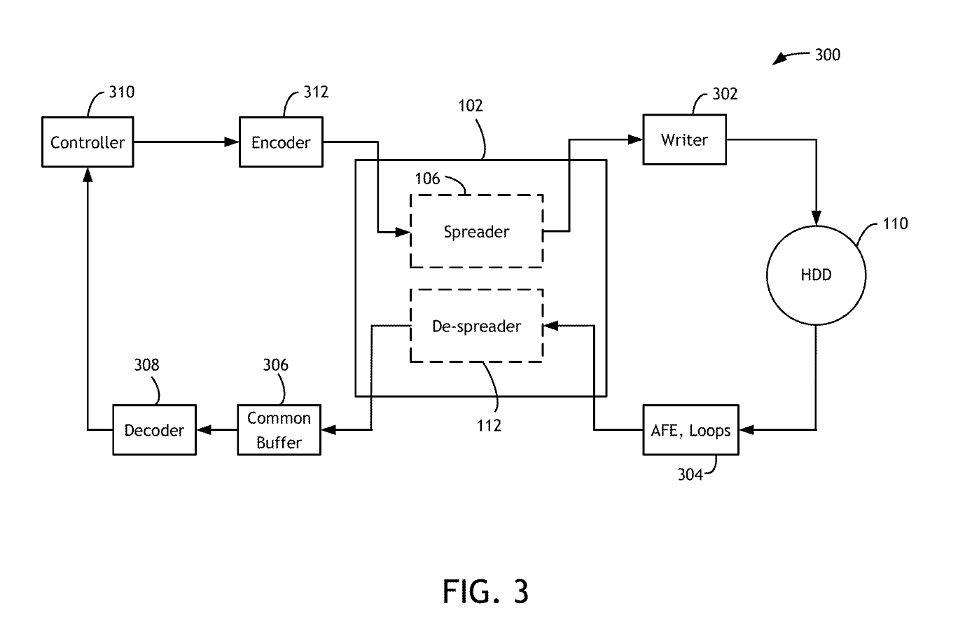

The data management system of the present disclosure includes additional elements in one embodiment as shown in FIG. 3. In FIG. 3, system 300 includes memory 102 which implements spreader module 106, and de-spreading module 112. The system 300 also includes storage device 110. The system 300 also includes an encoder 312, which receives the data from controller 310 and encodes it before sending it to the spreader module 106. The system 300 also includes writer 302, which is configured for writing the interleaved data to the storage device 110. The system 300 also includes analog front end 304, which is arranged between the storage device 110 and the memory 102. The system 300 also includes a common buffer 306 which is configured for holding the de-spread data sectors. The system 300 also includes a decoder 308 which receives the de-spread data sectors and performs decoding on the data sectors. This data is then sent to the controller 310.

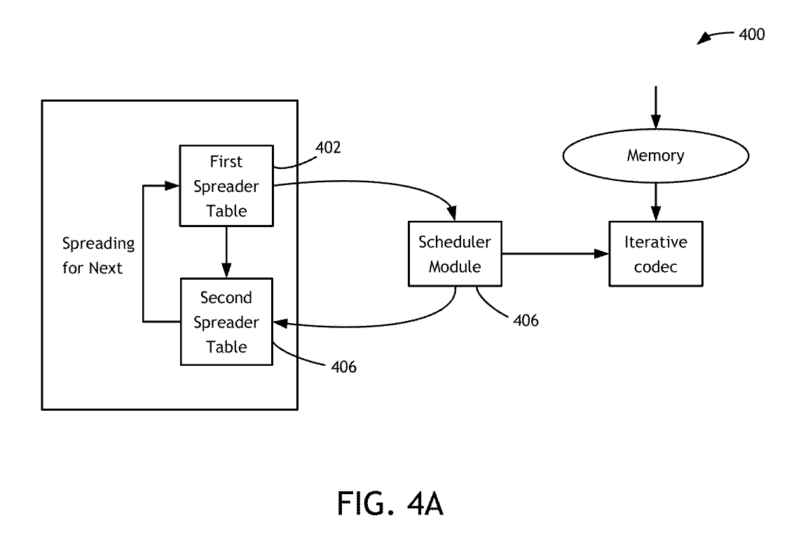

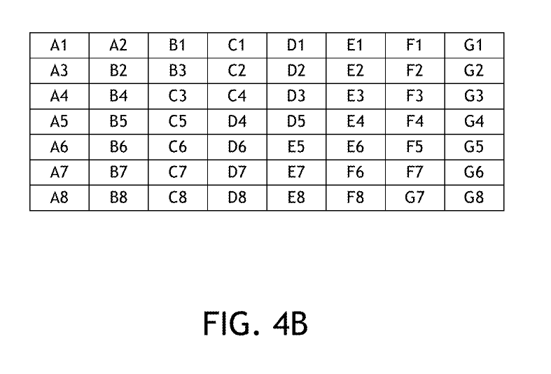

An additional embodiment of the present disclosure is provided in FIG. 4. In the system 400 shown in FIG. 4A, a common buffer may be combined with the spreading module and de-spreading module on the same memory. In the combined common buffer/spreading system, the memory space is managed dynamically and utilizes a ping-pong spreader table initialization. The system 400 includes a first spreader table 402 and a second spreader table 404. The system 400 also includes a scheduler module 406.

In operation, the first spreader table 402 includes Y samples, which are written into the memory of the first spreader table 402. Once the first spreader table 402 includes a full sector (including a plurality of interleaved data units that are ready to be de-spread), the data units of the sector are passed to the scheduler module 406. The space previously occupied by the full sector is then freed/cleared the first spreader table 402.

Once all of the space on the first spreader table 402 is full, all of the sectors inside of the first spreader table 402 may be transferred to the scheduler module 406 and be queued for de-spreading. After all of the data slot indexes on the first spreader table 402 have been freed by the scheduler module 406, the first spreader table 402 is idle until the second spreader table 404 switches roles with the first spreader table 402.

The scheduler module 406 receives the interleaved data from the first spreader table 402 once each sector of the interleaved data is ready for de-spreading. As each sector of the interleaved data is done de-spreading, the space previously occupied by that sector on the first spreader table 402 may be freed and made available by passing the space from the scheduler module 406 to the second spreader table 404. The scheduler module 406 removes the data slot indexes (previously occupied by the divided data units of the sector) from the block of memory before passing the memory block to the second spreader table 404. The scheduler module 406 is also configured to reclaim space and free up memory to pass to the second spreader table 404 if requested by the second spreader table 404.

The second spreader table 404 is configured to start spreading once the first spreader table 404 has completed its operation. The second spreader table 404 will start saving Y samples into data slot indexes designated by the second spreader table 404. The second spreader table 404 accepts freed up memory space from the scheduler module 406. If the second spreader table 404 runs out of memory for storing more Y samples, it will send a request to the scheduler module 406, which will respond by claiming space and passing it to the second spreader table 404. Once the second spreader table 404 is filled up, it will switch roles with the first spreader table 402.

In the embodiment of the present disclosure provided in FIGS. 4A and 4B, the memory space is managed dynamically. In one embodiment, a variable spreading size control management approach is taken. Each sector of the data is divided into a plurality of data units, which occupy a plurality of memory slots represented by the letter “N” on the first spreader table 402 or the second spreader table 404. The number of memory slots is represented as (N+m)*N. The memory slots occupied by the plurality of data units is represented as 0, 1, (N+m)*N−1 in one embodiment.

When the system 400 starts, the first spreader table 402 will record N*N memory slot indexes which can hold all of the data units corresponding to a full sector. The second spreader table 404 will start with m*N slot indexes. In cases where the number of sectors in a track are a non-integral multiple of N, the spreader size is mixed of N and N−1. For example, if K represents the number of sectors in a track, where K=a*N+b*(N−1), the sectors may be arranged as shown in FIG. 4B. In FIG. 4B, a first sector “A” is divided into eight data units which will occupy eight memory slots. A first data unit of sector A (unit A1) and a second data unit of sector A (unit A2) may be arranged next to each other as shown. Next, a first data unit of sector B (unit B1) is interleaved with A2, and a first data unit of sector C (unit C1) through sector G1. Next, a third data unit of sector A (unit A3) is interleaved with a second data unit of sector B (unit B3) through unit G2.

If a spread sector contains N−1 sectors, the spreader full condition would be met if the spreader has (N−1)*N number of slots instead of N*N slots. The maximal number of sectors for processing in the scheduler module is (m+N−1) sectors. The combined common buffer and spreader memory scheme shown in FIGS. 4A and 4B provides advantages in one embodiment by allowing efficient memory usage and allocation.

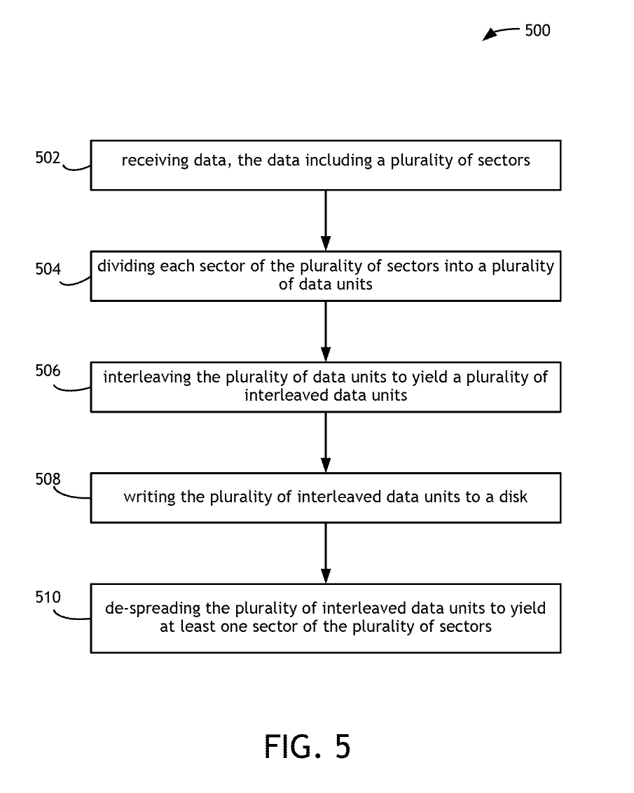

The present disclosure is also directed to the method 500 for managing a memory shown in FIG. 5. The method 500 includes the step of receiving data 502. The data is comprised of a plurality of sectors. The method 500 also includes the step of dividing each sector of the plurality of sectors into a plurality of data units 504. A further step of the method 500 involves interleaving the plurality of data units to yield a plurality of interleaved data units 506. The method 500 also includes the step of writing the plurality of interleaved data units to a disk 508. An additional step of the method is to de-spread the plurality of interleaved data units to yield at least one sector of the plurality of sectors 510.

In one embodiment, the method 500 includes additional steps. A further step of the method 500 may include de-spreading the plurality of interleaved data units to yield an additional sector. The method 500 is used to de-spread the plurality of interleaved data units to yield each sector of the plurality of sectors.

In one embodiment, the method 500 is implemented to manage data that includes sixteen sectors having a size of 4 kilobytes each. Those skilled in the art will appreciate that the method 500 is not limited to the embodiments described and may include different numbers of sectors without departing from the scope of the present disclosure. In another embodiment of the invention, the data includes additional sectors. The method 500 is suitable for managing data with any number of sectors. The additional sectors may be interleaved together, stored, and then de-spread.

In one embodiment, the systems and methods of the present disclosure are suitable for shingled recording where the writing of data is sequential and there is no random writing.

One advantage of the systems and methods of the present disclosure is that spreading the data over a longer physical location may help to improve and average out the signal to noise ratio and the error rate. In addition, block by block interleaving instead of bit by bit or symbol by symbol interleaving may help to save common buffer usage. The step of dividing the data into a plurality of data units and then interleaving the data and saving the interleaved data to the storage device separates the data units of the same data sector into different locations on the storage device, instead of consecutive locations on the storage device. In one embodiment, this provides the advantage of improving the signal to noise ratio for the data.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The foregoing detailed description may include set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein may be capable of being distributed as a program product in a variety of forms, and that an illustrative embodiment of the subject matter described herein applies regardless of the particular type of signal bearing medium used to actually carry out the distribution. Examples of a signal bearing medium include, but may be not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

Those having skill in the art will recognize that the state of the art may include progressed to the point where there may be little distinction left between hardware, software, and/or firmware implementations of aspects of systems; the use of hardware, software, and/or firmware may be generally (but not always, in that in certain contexts the choice between hardware and software may become significant) a design choice representing cost vs. efficiency tradeoffs. Those having skill in the art will appreciate that there may be various vehicles by which processes and/or systems and/or other technologies described herein may be effected (e.g., hardware, software, and/or firmware), and that the preferred vehicle will vary with the context in which the processes and/or systems and/or other technologies may be deployed. For example, if an implementer determines that speed and accuracy may be paramount, the implementer may opt for a mainly hardware and/or firmware vehicle; alternatively, if flexibility may be paramount, the implementer may opt for a mainly software implementation; or, yet again alternatively, the implementer may opt for some combination of hardware, software, and/or firmware. Hence, there may be several possible vehicles by which the processes and/or devices and/or other technologies described herein may be effected, none of which may be inherently superior to the other in that any vehicle to be utilized may be a choice dependent upon the context in which the vehicle will be deployed and the specific concerns (e.g., speed, flexibility, or predictability) of the implementer, any of which may vary. Those skilled in the art will recognize that optical aspects of implementations will typically employ optically oriented hardware, software, and or firmware.

What is claimed is:

1. A method for managing data, the method comprising:
receiving data, the data including a plurality of sectors;
dividing each sector of the plurality of sectors into a plurality of data units;
interleaving the plurality of data units to yield a plurality of interleaved data units;
writing the plurality of interleaved data units to a disk; and
de-spreading the plurality of interleaved data units to yield at least one sector of the plurality of sectors.

2. The method as claimed in claim 1, further comprising:
sending the at least one sector of the plurality of sectors to a controller.

3. The method as claimed in claim 1, further comprising:
de-spreading the plurality of interleaved data units to yield each sector of the plurality of sectors.

4. The method as claimed in claim 1, wherein the method is implemented on a memory.

5. The method as claimed in claim 1, wherein the method is implemented on a combined memory and common buffer.

6. The method as claimed in claim 1, wherein the plurality of sectors includes sixteen sectors having a size of 4 kilobytes each.

7. The method as claimed in claim 1, further comprising:
releasing space occupied by the plurality of interleaved data units when the plurality of interleaved data units have been de-spread.

8. A system for managing data, the system comprising:
a memory, the memory configured for storing the data, the data including a plurality of sectors;
a spreader module, the spreader module configured for dividing each sector of the plurality of sectors into a plurality of data units, the spreader module further configured for interleaving the plurality of data units to yield a plurality of interleaved data units, the spreader module further configured for sending the plurality of interleaved data units to a storage device, the storage device configured for storing the plurality of interleaved data units;
a de-spreading module, the de-spreading module configured for receiving the plurality of interleaved data units from the storage device and de-spreading the plurality of interleaved data units to yield at least one sector of the plurality of sectors.

9. The system as claimed in claim 8, wherein the de-spreading module is further configured for de-spreading the plurality of interleaved data units to yield each sector of the plurality of sectors.

10. The system as claimed in claim 8, further comprising:
a common buffer, the common buffer configured to receive the at least one sector of the plurality of sectors from the de-spreading module.

11. The system as claimed in claim 8, wherein the system is combined with a common buffer.

12. The system as claimed in claim 11, wherein the spreader module includes a first spreader table and a second spreader table.

13. The system as claimed in claim 12, further comprising:
a scheduler module, the scheduler module configured for receiving the plurality of interleaved data units from the spreader module and sending the plurality of interleaved data units to the de-spreading module.

14. The system as claimed in claim 13, wherein the scheduler module is further configured for clearing a space on the spreader module.

15. A system for dynamically managing data, the system comprising:
a memory, the memory configured for storing the data, the data including a plurality of sectors;
a spreader module, the spreader module including a first spreader table and a second spreader table, the first spreader table configured for dividing each sector of the plurality of sectors into a plurality of data units, the first spreader table further configured for interleaving the plurality of data units to yield a plurality of interleaved data units, the first spreader table configured to send the plurality of interleaved data units to a scheduler module, the second spreader table configured to divide each sector of the plurality of sectors into a plurality of data units and interleave the plurality of data units when the first spreader table is full,
a scheduler module, the scheduler module configured for receiving the plurality of interleaved data units from the spreader module and sending the plurality of interleaved data units to the de-spreading module; and
a de-spreading module, the de-spreading module configured for receiving the plurality of interleaved data units from the storage device and de-spreading the plurality of interleaved data units to yield the at least one sector of the plurality of sectors.

16. The system as claimed in claim 15, wherein the scheduler module is further configured for releasing space on the spreader module.

17. The system as claimed in claim 15, wherein the de-spreading module is further configured for de-spreading the plurality of interleaved data units to yield each sector of the plurality of sectors.
